(19) United States
(12) Patent Application Publication
(10) Pub. No.: US 2003/0080185 A1
(43) Pub. Date: May 1, 2003

(54) Money transfer method and system

(76) Inventor: Ellen R. Werther, New York, NY (US)

Correspondence Address: Jonathan S. Caplan, Esq., Kramer Levin Naftalis & Frankel LLP, 919 Third Avenue, New York, NY, 10022, US

(21) Appl. No.: 10/036,078

(22) Filed: Oct. 26, 2001

(51) Int. Cl. G06K 5/00

(52) U.S. Cl. 235/380

(57) ABSTRACT

A system for dynamic, real time transfer of money electronically from one individual to another without the need for either the transferor or transferee to have credit card or bank account, uses, for example, existing ATM networks. Real-time fund transfers can be further controlled based on selected criteria. The method includes depositing cash or check funds into a transferor primary account coupled to a financial network wherein the cash or check funds are immediately available for transfer, transferring a portion of the funds to a transferee account which is a subaccount of the transferor primary account, and withdrawing funds from the transferee account using a transferee account access card and a personal identification number from any access point in the financial network. In alternative embodiments, funds can be deposited directly to transferee accounts. The system and method provide easy and convenient electronic money transfer with immediate availability of funds for money transfer from a sender's account without requiring either the sender or recipient to have a bank account or credit card. It is especially beneficial for members of the unbanked population.

### FIELD OF THE INVENTION

The present invention relates generally to methods and systems for electronically transferring currency for disbursement quickly, cheaply and conveniently, and more particularly to a method and system for transmitting money through the use of automated teller machines (ATMs), without the need for a bank account or credit card account.

### BACKGROUND INFORMATION

To quickly and conveniently transfer money, a customer (also referred to as “sender”) generally has to have either (i) a credit card against which cash can be withdrawn, or (ii) a funded bank account so that funds are readily accessible. When such a customer transfers money between banks, the intended recipient is also required to have a bank or brokerage account. If a customer does not have a bank account or a credit card, such money-transferring methods will not work. Although various methods are currently available for transferring money from one location to another without a credit card or a bank account, these methods all suffer from several undesirable features and have not changed much since their original conception many years ago.

One existing method of transferring funds to others is by wire transfer through a major financial institution such as a bank, credit union or brokerage house. For example, an individual wishing to transfer money to another at a different location would go to a first wire transfer office (e.g., the sender's bank) and have money wired to a second wire transfer office in the city where the recipient is located. This method generally requires that the sender has an account with and/or pay a fee to the sending institution. In addition, this method assumes that the second wire transfer office is conveniently located to the recipient. Furthermore, it assumes that the second wire transfer office is open at a convenient time for the recipient. This method can be impractical for members of the unbanked population. For example, most situations where currency must be transferred from one location to another are emergency situations. Thus, a member of the unbanked population may not have the time or money to open an account under the circumstances. Furthermore, convenient hours may not exist, and the second wire transfer office may not be readily accessible to the recipient.

Another method for transferring funds uses automated teller machines (ATMs), which are well known for conveniently providing an individual with easy access to bank and credit card accounts, which may be held at various financial institutions. In recent years, the availability of ATMs has increased such that it is commonplace for an individual to use such machines for the withdrawal of funds from various accounts regardless of whether or not the user's bank is open or closed. In fact, ATMs are often found in malls, supermarkets, and other areas where banks are not even present. Using certain ATMs, an individual also can obtain currency (e.g., a cash advance) from a credit card. If the account has more than one cardholder, each cardholder can access the account through an ATM and withdraw funds. Currently, it is not possible for one client to transfer funds from his or her account to a third party's separate account through the ATM system.

A variety of cards exist for providing an individual with access to ATMs. A typical card includes a magnetic strip on which information for a particular account or accounts is encoded. Specialized terminals can then read the magnetic strip. For example, the account number can be read and transmitted over a network along with an identification number and the amount of the transaction in order to receive verification and approval. Prior to authorizing the transaction, a remote central computer queries a database associated therewith to determine if the transaction amount is within the limit of the individual's account balance.

Several ATM systems exist in the United States and around the world. These systems are interlinked such that an individual may travel to virtually any location and retrieve money from their account using a local ATM. As is well known in the art, an account is accessed by, for example, inserting a card in an ATM machine and supplying a preassigned Personal Identification Number (PIN). Upon verification of the PIN, the individual is provided access to their account and may withdraw funds therefrom. The ATM also allows individuals to perform various other transactions, including balance inquiries, statements for a prior period of time, and transfers from the client's primary account to a secondary account such as a savings account. The use of the ATM is facilitated by a keypad, touch screen and/or various function keys. The keypad allows the user to enter specific numerical information, while the touch screen and function keys allow quick responses to various questions or prompts. For example, the individual is also provided with such conveniences as the selection of a preferred language for conducting the current session at the ATM.

The unbanked population, however, which lacks bank accounts or credit cards, currently are not able to take advantage of the convenience offered by conventional ATM networks. Even people with an unfunded or minimally funded bank account cannot fully enjoy the convenience offered by ATM networks. They have no way to quickly and conveniently deposit funds into an account for transfer to a third party over the ATM network. If they try to deposit a check through the traditional envelope method available at many ATMs they must wait a significant period of time for those funds to actually be available for transfers. For example, first the deposited check must be picked up from the ATM, the envelope opened, the check deposited by a bank representative and actually cleared before the funds are available for transfer. This can take well over a week or more in many cases. In an emergency, this method is not a practical approach for quickly depositing and transferring funds to a third party. Thus, many individuals are forced to use third party financial service providers, such as western Union, who will take cash and transfer the funds to a third party for a significant fee (often 15% or more of the principal amount of the transfer).

For example, Western Union uses a self-contained money transfer system and generally does not access the global ATM network for delivery of funds. Instead, funds are transferred over a private Western Union network. Western Union customers have, for example, three ways to deposit funds into the Western Union system. First, they can pay cash to a teller. Second, they can put value in by charging their credit or debit card if they have one. Third, the customer can use online banking to transfer funds from his or her bank account. Since unbanked individuals do not have credit or debit cards or bank accounts, they are limited to paying cash for Western Union money transfers.

The cash payment method for Western Union requires that a customer go in person to a Western Union office and deliver cash to the teller, a portion of which will be transferred to a third party and a portion of which is a fee to Western Union. It is possible for Western Union to use certain advanced ATM equipment (e.g., such as manufactured by NCR Corporation of Dayton, Ohio), which can accept cash into a “cash bunch acceptor” or checks into a “check acceptor” and would allow the client to deposit cash into the system without having to visit a Western Union office. These ATMs are used by Western Union at, for example, certain convenience stores in the United States to sell money orders and perform other transactions, such as the withdrawal of funds already in or electronically available to the Western Union system. However, these specialized ATMs are not used by Western Union or any other financial services provider to accept cash and/or checks and quickly transfer those funds to a third party.

Once funds are deposited into the Western Union system for transfer to a third party, then the customer is issued a one time PIN, which enables the transferee to withdraw funds from a Western Union office in the transferee location. The transferee is not required to have a card (e.g., this is not a card-to-card transfer). The sender calls the intended recipient, advises him or her that the transfer has been made, and provides the PIN that must be used to receive the funds. Any currency conversion, if necessary, is made by Western Union (for a fee) and the transferee also often has to pay withdrawal fees in the local jurisdiction to receive the funds. Generally, the transferred funds are not immediately available and are aggregated with other funds in a common interest bearing Western Union account. In total, the Western Union transfer process can cost the sender and recipient as much as 20-25% of the principal amount.

Known money transfer methods and systems include several U.S. patents. For example, U.S. Pat. No. 5,650,604 to Marcous et al. describes a method for electronic transfer of funds using an ATM to dispense the transferred funds, including transfers by a member of the unbanked population or a person with an unfunded bank account to transfer money by presenting cash to an agent. In this scenario, the agent would in turn interact with the system as if the agent were the “sender.” Thus, in this case, the transferred funds would first come out of an omnibus account. As discussed previously, such an approach has several drawbacks. It has to take place in person at a money transfer facility, such as a bank, and occur during normal business hours. These limitations limit the usefulness of the method in cases of inconvenient locations and/or hours.

U.S. Pat. No. 4,761,542 to Kubo et al. discloses an automatic money receiving and paying method and apparatus. Various types of guidance information are stored in advance in the automatic money receiving and paying apparatus. Necessary information is then selected from the various types of guidance information on the basis of user characteristics so that proper guidance may be provided. It does not, however, provide a system or method of transferring funds without any existing banking relationships on the part of both the transferee and the transferor.

U.S. Pat. No. 5,064,999 to Okamoto et al. discloses an advance transaction processing method for conducting transactions on an ATM. The method involves registering transactions, assigning data for assigning transaction operations to be conducted by the user, a transaction restriction condition, and a card identifying data on the card carried by the user. A transaction-operational procedure is stored in a storage device of the central processing unit by using the transaction assigning data as a key for search. When a card (e.g., a magnetic strip card) is inserted into the ATM, confirmation is provided as to whether the transaction restriction condition is satisfied. The transaction operational procedure is then read and the ATM is allowed to process the transaction. It provides a method to process advance transaction over an ATM instead of traditional over-the-counter service. The transaction however, requires a bank affiliation and a bank card.

U.S. Pat. No. 5,175,416 to Mansvelt et al. also discloses a method of transferring funds. In this method, a first “smart card” is linked to a first financial institution. The first smart card then debits an account held at the first financial institution and records a corresponding credit value in the first smart card. The first smart card is linked to a second, similar device so that the credit value in the first device is reduced and a corresponding credit value is recorded in the second device. The second device is then linked to a second financial institution and the credit value in the second device is reduced while a corresponding credit value is recorded in an account held at the second financial institution. The first and second devices each store at least a portion of a program, which is run in a synchronized interactive manner between the first devices. This money transferring method requires accounts with both sending and receiving financial institutions. In addition, a “smart card” is needed in the transaction.

U.S. Pat. No. 5,326,960 to Tannenbaum discloses a currency transfer system and method, which utilizes the existing ATM network. The system is capable of temporarily assigning a PIN number and temporarily establishing a credit limit within an existing account. The system allows a customer to withdraw an amount equal to or less than the temporary credit limit by using the temporary PIN at an ATM machine. The depositing customer can establish a temporary credit limit by transferring funds from an existing account or the depositing customer can purchase temporary ATM cards, which contain preprogrammed credit limits. The credit limits are then read into the system under an assigned temporary PIN number. This method involves purchasing an ATM card from an agent, and the transferred funds would first come out of an omnibus account.

U.S. Pat. No. 5,477,038 to Levine et al. discloses a method and apparatus for distributing currency. The method provides a process, which allows electronic access to pre-paid funds for cash or payment for goods and services. The customer selects monetary value to be contained on an issued card, which has a magnetic strip on the surface thereof with an encoded card number including a bank identification number and an account number. The central card processor establishes a zero balance database including card numbers. The database includes blank fields for customer data and the value of the account. Upon purchase of a card, the sales agent transmits customer information to the central database so that the account may be activated. This approach also involves purchasing from a sales agent a card, which is linked to a centralized system. Thus, it is inconvenient for the sender, requires an in person purchase or the pre-paid card or a bank account or credit card with which to fund the pre-paid card. The pre-paid funds are held in an omnibus account before the cardholder uses them.

U.S. Pat. No. 5,937,396 to Konya discloses a system for transferring currency electronically between accounts. The system allows currency to be immediately transferred from a first account to an ATM. The ATM provides the individual with a plurality of transaction choices such as the transfer of an amount of currency to a second account. The ATM transmits information to a main computer regarding the second account and the amount of currency to be transferred. A transaction card associated with the second account is used to compare the recipient account to the account number provided by the sender. The transferred currency can then be retrieved using a second ATM. The transaction card is used solely to identify the recipient and currency is not actually transferred to the second account. This electronic money transfer system requires two existing accounts with financial institutions and this is not suitable for people without an existing account.

### SUMMARY OF THE INVENTION

The present invention provides a system for dynamic, real time transfer of money electronically from one individual to another without the need for either the transferor or transferee to have credit card or bank account, using, for example, existing ATM networks. The present invention also provides a method to control real-time fund transfers based on selected criteria, such as a number of transfers made by the transferor, the amount of funds transferred by the transfer, the number of transfers made to the transferee or the total amount of transfers to the transferee.

According to an exemplary embodiment of the present invention, a method for transferring money without using a credit card or bank account, comprises:

a. creating a transferor primary account coupled to a financial network;

b. creating a transferee account, which is a subaccount of the transferor primary account;

c. depositing cash or check funds into the transferor primary account wherein the cash or check funds are immediately available for transfer to the transferee account;

d. dynamically transferring a portion of the funds in the transferor primary account to the transferee account;

e. using a transferee account access card and a personal identification number to obtain the transferred funds only from the designated transferee account from any access point in the financial network.

According to another exemplary embodiment of the present invention, a method for transferring money without using a credit card or bank account, comprises:

a. creating a transferor primary account coupled to a financial network;

b. creating a transferee account, which is a subaccount of the transferor primary account;

c. depositing cash or check funds directly into the transferee account;

d. using a transferee account access card and a personal identification number to obtain the transferred funds only from the designated transferee account from any access point in the financial network.

According to a further exemplary embodiment of the present invention, a system for transferring money without using a credit card or bank account, comprises:

a. an initiating ATM receiving (i) a funds deposit wherein the funds deposit is immediately available for use from a transferor primary account and (ii) a designation of an amount of the funds deposit to be transferred to a transferee account which is a subaccount of the transferor primary account;

b. a central computer system coupled to the initiating ATM, the central computer system including a processor function and an authorizer function to facilitate the deposit, transfer and withdrawal transactions;

c. a transferee ATM coupled to the central computer system, the transferee ATM (i) receiving a funds withdrawal request, the subaccount number and the personal identification number, (ii) providing the funds withdrawal request, the subaccount number and the personal identification number to the central computer for authorization, (iii) receiving authorization, and (iv) dispensing the authorized funds in a local currency.

According to still another exemplary embodiment of the present invention, a system for transferring money without using a credit card or bank account, comprises:

a. an initiating ATM receiving a funds deposit directly into a transferee subaccount which is a subaccount of a transferor primary account, the funds deposit being available for use substantially immediately;

b. a central computer system coupled to the initiating ATM, the central computer system including a processor function and an authorizer function to facilitate the deposit and withdrawal transactions;

c. a transferee ATM coupled to the central computer system, the transferee ATM (i) receiving a funds withdrawal request, the transferee account number and the personal identification number, (ii) providing the funds withdrawal request, the transferee account number and the personal identification number to the central computer system for authorization, (iii) receiving confirmation of authorization, and (iv) dispensing authorized funds in a local currency.

The system and method of the present invention provide easy and convenient electronic money transfer with immediate availability of funds for money transfer from a sender's account without requiring either the sender or recipient to have a bank account or credit card. It is especially beneficial for members of the unbanked population. For example, by eliminating agents and dedicated facilities for the delivery of funds, the cost of the transaction is greatly reduced while the duration of the transaction is shortened. Unlike conventional transfer services such as Western Union, the present money transfer methods and systems make funds available immediately and thus no financial institution profits from a mandatory float period. Currency exchange also can be made at more favorable rates than conventionally available. Additional benefits achieved with the present invention include allowing individuals to transfer money at the customer's (e.g., both the sender's and the recipient's) convenience twenty-four hours a day, seven days a week. The transferee can further enjoy the convenience of receiving transferred funds at any nearby ATM anywhere in the world.

### BRIEF DESCRIPTION OF THE DRAWINGS

FIG. 1 is a diagram of an exemplary money transfer system in accordance with an embodiment of the present invention.

FIG. 2 is a view of an ATM for use according to an exemplary embodiment of the present invention.

FIG. 3A is a top view of an exemplary user card for use with an ATM according to an exemplary embodiment of the present invention.

FIG. 3B is a bottom view of an exemplary user card for use with an ATM according to an exemplary embodiment of the present invention.

FIG. 4 is an exemplary flowchart illustrating a procedure for a deposit transaction according to an exemplary embodiment of the present invention.

FIG. 5 is an exemplary flowchart illustrating a procedure for a withdrawal transaction according to an exemplary embodiment of the present invention.

### DETAILED DESCRIPTION OF THE INVENTION

According to an exemplary embodiment of the present invention, a transaction is initiated when an individual desires to transfer money to a third party, such as a friend or relative. The recipient can be located in any location where there is access to an ATM network. According to an exemplary embodiment of the present invention, no credit or debit card or bank relationship is required. Initially, a transferor's primary account is established and linked to multiple transferee subaccounts. For example, primary accounts and linked subaccounts can be pre-established and assigned to customers during a registration process that occurs prior to the first transaction by a customer. The magnetic strip cards for each account also can be provided during the registration process. Each of these accounts is accessible through, for example, the respective a magnetic strip card. The transferor is assigned a PIN and each transferee subaccount card also is assigned a separate PIN.

Each transferee subaccount card (and associated PIN) can be used to access only the particular transferee subaccount and does not provide access to funds in the transferor primary account or to any funds in any other transferee subaccount related to that primary account. A transferor primary account, on the other hand, can access all linked transferee subaccounts. This feature is useful because, for example, if the funds in a transferee account are not picked up, the transferor can access the transferee account directly and remove the funds. Once a customer registers with the funds transfer service, the primary account holder mails or otherwise provides the transferee card to the intended funds recipient and advises him or her of the associated PIN. As soon as the recipient has possession of the transferee card and is made aware of the associated PIN, that recipient can receive multiple transfers from the primary account holder.

To transfer funds, the sender simply deposits cash into the cash bunch acceptor or a check into the optical check reader/acceptor at an ATM operating in accordance with an embodiment of the present invention. This ATM has the ability to count the cash and/or read and validate the check(s), and give the depositor immediate access to the deposited funds. An ATM capable of operating in accordance with an embodiment of the present invention is, for example, Model P70 or Model P72 (with Side Car), or Model P78, manufactured by the NCR Corporation of Dayton, Ohio. Once deposited into the ATM, the funds are ready to be transferred. The funds can be transferred, for example, one of two ways. Either the depositor indicates that a portion of the deposit should be transferred from the primary account to a transferee subaccount, or the depositor indicates that the entire deposit should be made directly to a transferee subaccount. Once the primary account holder directs funds to the transferee subaccount in this manner, the recipient can withdraw the funds from any ATM in an existing ATM network.

The sender can essentially immediately transfer all or a portion of the funds, minus a predetermined fee, to the transferee subaccount, which is a subaccount linked to the sender's primary account. Once the funds are in the transferee accounts, the sender has authorized a third party (e.g., a friend or relative) to withdraw funds from that designated subaccount. According to an embodiment of the present invention, each authorized third party may withdraw funds only from his or her designated subaccount and may not access the primary account or any other subaccount the sender may have established. In an alternative embodiment of the present invention, once the sender transfers funds to a subaccount, the ATM can generate a new personal identification number (hereinafter “PIN”) for the transferee. Otherwise, the PIN originally assigned to the subaccount card may be used multiple times by the transferee.

The present invention can be described with regard to two aspects of a transfer transaction, which will hereinafter be referred to as deposit and withdrawal.

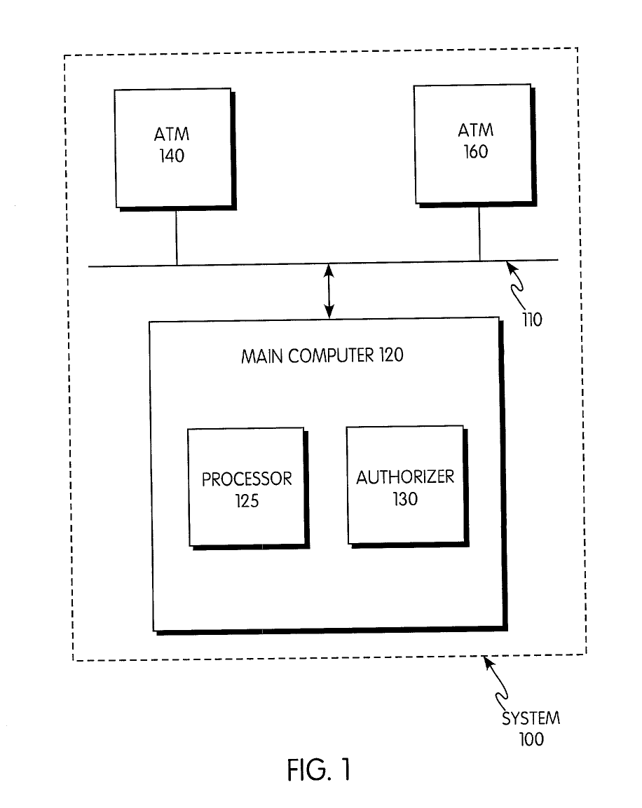

The deposit process includes, for example, funds deposit and transfer to a transferee subaccount. With reference to FIG. 1, an exemplary system 100 is shown for transferring funds deposited into a primary account to a transferee account. The system 100 includes, for example, a first ATM 140, a second ATM 160 and a main computer 120 coupled to the ATMs by, for example, a conventional ATM network connection 110. Main computer 120 further includes, for example, a processor function 125 and an authorizer function 130 to facilitate the deposit, transfer and withdrawal operations. Network connection 110 can include, for example, a LAN, WAN, PSTN, Internet, optical, wireless or other suitable communication link. A service provider works in conjunction with system 100 to facilitate the funds transfer. For example, the service provider provides a funds transfer system through policies and procedures as well as account administration and oversight for the transactions carried out on system 100 as described below. The system 100 takes in deposited funds, in the form of cash or check, and allows money to be immediately transferred from the primary account to a subaccount, so that the money may be readily accessed by a third party recipient.

First ATM 140 and second ATM 160 can operate in a similar manner, although only first ATM 140 (e.g., the sender's ATM) requires some of the special capabilities described herein. In certain embodiments of the present invention, first ATM 140 and second ATM 160 can be the same machine. Since the deposited funds are intended to be virtually immediately available for use according to an embodiment of the present invention, first ATM 140 must be able to independently count the amount of deposited cash and/or read and verify the amount of deposited checks. To accomplish this, first ATM 140 includes a cash deposit acceptance mechanism, sometimes referred to as a “cash bunch acceptor” that can count the amount of any deposited cash. In alternate embodiments, the deposited cash can be in any known currency in addition to U.S. currency.

In addition, first ATM 140 includes a check deposit acceptance mechanism, referred to as a “check acceptor,” which can read and verify different types of checks having known formats, such as federal or state government checks or certain payroll checks. For example, using optical reading technology, the MICR encoding on a check, which includes the ABA routing code, account number and check number, can be read and used to identify the check. The amount of the check can be read as well also using, for example, known optical reading techniques. In one embodiment of the present invention, the check acceptor will limit the acceptable checks to federal or state government checks and certain payroll checks although other checks such as personal checks, could be accepted if desired. In another embodiment of the present invention, first ATM 140 can reject damaged cash and/or checks. An ATM having such a deposit acceptance mechanism is manufactured by, for example, the NCR Corporation of Dayton, Ohio. Other features of ATM 140 and ATM 160 are conventional as is known in the art.

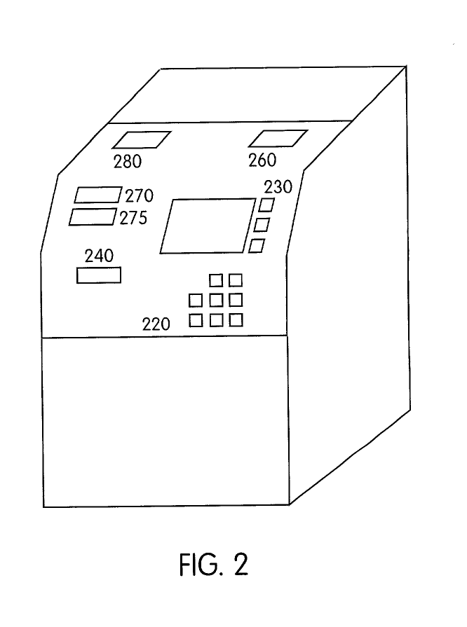

FIG. 2 illustrates an exemplary first ATM 140 shown in an enlarged manner so as to illustrate certain details associated therewith. For descriptive purposes, only the details of the first ATM 140 will be discussed. However, it should be noted that the first ATM 140 may be identical to the second ATM 160. Thus, all details of the first ATM 140 are equally applicable to the second ATM 160. It should also be appreciated that typical ATMs are quite complex in nature but their functions and capabilities are well known in the art.

First ATM 140 includes, for example, a display 210 and a keypad 220 for performing various transactions on an account. The display 210, which can be a LED, LCD, touchscreen or other suitable display, provides a plurality of transaction choices from which an individual may select using, for example, the keypad 220. The display 210 is also capable of providing instructional information as to the operation thereof. A plurality of function keys 220 may also be provided in order to reduce the number of transaction choices which must be made in order to complete certain common transactions. According to an embodiment of the present invention, ATM 140 includes a cash deposit acceptance mechanism 270 and a check deposit acceptance mechanism 275, which may be individually or jointly located on ATM 140. Cash acceptance mechanism 270 and check deposit mechanism 275, such as provided in Models P70, P72 and P78 ATMs made by NCR Corporation of Dayton, Ohio, allows ATM 140 to independently count the amount of deposited cash and/or read and verify the amount of deposited check.

The first ATM 140 also includes a currency dispenser 260 and receipt dispenser 280. The receipt dispenser 280 functions in conjunction with a printing device disposed within the first ATM 140. As is known in the art, the printing device is used to prepare a transaction report, which an individual can keep for their personal records. First ATM 140 also includes a conventional card reader 240. The card reader 240 is capable of, for example, reading the information stored on the magnetic strip 390 of the transaction card 300. Accordingly, care must be taken in inserting the transaction card 300 since the magnetic reader 240 will often expect the magnetic strip 390 to be disposed in a predetermined orientation. Upon insertion of the transaction card 300 into the magnetic reader 240, first ATM 140 verifies an individual's access to the account encoded thereon. This is accomplished by, for example, entering the preassigned PIN by means of the keypad 220. Similarly, the various transaction choices provided by the second ATM 160, which is similar to ATM 140, allow the individual to elect to retrieve transferred funds.

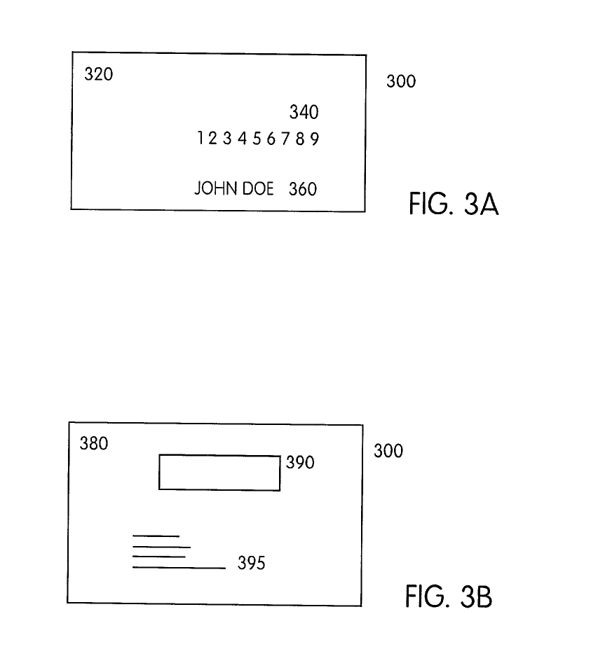

An exemplary transferee card used by transferee to receive the transferred funds according to an embodiment of the present invention is illustrated in FIGS. 3A and 3B. Transaction card 300 is typically constructed of plastic, such as a conventional magnetic strip debit card or credit card. The transaction card 300 includes, for example, a front surface 320 and a rear surface 380. Along the front surface 320 there is often displayed an account number 340 identifying the account to which the transaction card 300 is associated. The name 360 of the individual to whom the account belongs may also be provided on the front surface 320. Front surface 320 or rear surface 380 also may include a logo of the service provider or other form of branding.

The rear surface 380 of the transaction card 300 contains, for example, a conventional magnetic strip 390 on which information pertaining to the account is stored. This information often includes the account number and routing code of the financial institution or organization issuing the transaction card 300. The rear surface 380 may further include various information, illustrated by the numeral 395, pertaining to the operation of the transaction card 300.

Main computer 120 includes, for example, a microprocessor-based computer system including a memory, which receives and stores primary and subaccount number(s) associated with the sender transmitted from ATMs 140, 160. Main computer 120 has, for example, conventional hardware such as memory, data storage and retrieval devices and communication devices. Main computer 120 executes, for example, an independent software program stored in memory for transferring funds and creating and maintaining a database storing transaction information as is known in the art. The main computer 120 further includes, for example, a processor function 125 and an authorizer function 130.

In an embodiment of the present invention, processor function 125 and authorizer function 130 include two separate but connected computers within main computer system 120. In an alternative embodiment of the present invention, the processor function 125 and authorizer function 130 can be performed in the same computer system. The processor function 125 and authorizer function 130 can be considered distinct and may be handled by separate third party service providers. The processor function 125 may be performed by, for example, a computer system operated by a third party company such as Concord EFS, Inc., one of the largest processors of electronic financial transactions in the United States. The authorizer function 130 may be performed by, for example, a computer system of a banking institution or a third party service provider such as FiServe, a company with a division dedicated to authorizing electronic financial transaction. For illustrative purposes, first ATM 140 is used in connection with the transferor's primary account and subaccounts, while the second ATM 160 will be used in connection with the recipient's access of the subaccount. As noted earlier, the recipient may use any ATM, including the first ATM 140, to access the subaccount to obtain transferred funds. Both ATM 140 and ATM 160 are connected to the main computer 120 through communication link 110.

It should be appreciated that various other methods exist for linking the first and second ATMs 140, 160. For example, current ATM systems are interlinked through various ATM networks. Each ATM network includes its own computer system, which may be subsequently interlinked with the computer system of another ATM network. In such instances, it is necessary for the first and second ATMs 140, 160 to establish interactive connections with the computer systems of their respective ATM networks prior to accessing the computer systems of the other ATM network. Thus, as described herein connections between the first and second computer systems are understood to incorporate any intermediate connections to secondary ATM networks, which are necessary to facilitate the transaction.

To carry out a transfer according to an exemplary embodiment of the present invention, initiating ATM 140 starts with a funds deposit. When a sender uses the system for the first time, a sender's primary account, as well as one or more transferee subaccounts, need to be established. In one embodiment of the present invention, account cards and pre-established primary accounts with associated subaccounts are provided to a customer upon registration with the funds transfer service. For example, these cards may be picked up at local affiliated stations, such as community based organizations, supermarkets, convenience stores, and/or bank branches where the funds transfer service is available. Such primary accounts and subaccounts may be pregenerated by the processor function 125, the user's information being associated with the account information at the time of registration. For example, when a customer picks up the primary account card and associated subaccount cards, the customer would provide personal information associated with the account to a service representative who will provide the information to the fund transfer service provider, for example, by entering the customer's information into a computer system linked to main computer 120, which in turn provides the information to processor function 125 and authorizer function 130. Thus, the customer's information is mapped to the pre-generated accounts, and the customer's primary account and associated subaccounts are now established.

Alternatively, a customer's primary account and subaccounts may be established at, for example, first ATM 140, through the use of an on-line registration process. For example, a sender may enter his/her personal information at first ATM 140, by using, for example, a touch screen or keypad. Pre-generated cards linked automatically to a primary account and associated subaccounts (with associated PINs) can be dispensed at the ATM terminal. Similar to the off-line registration process described above, the customer's information would be transmitted to the main computer 120, associated with the pre-generated cards and stored in processor function 125 and authorizer function 130.

Once primary accounts and associated subaccounts are established, a customer may start a money transfer transaction by depositing funds into the account(s). The customer selects, for example from the keypad or the touch screen of ATM 140, the appropriate option to perform a transfer operation. When the sender begins interacting with system 100 via ATM 140, the sender is preferably told promptly about any transaction fee to be assessed to perform the desired transaction. The transaction fee can be, for example, a percentage of the principal transferred, for example 7 percent, or a fixed amount for any transfer under a certain limit, for example 7 dollars for any transfer up to 100 dollars. The customer has the option to deposit cash and/or check(s). The customer simply deposits cash in a cash bunch acceptor or check into a check acceptor at ATM 140. As explained previously, ATM 140 has the capacity to read the cash and/or checks, authenticate them and give the depositor immediate credit for the deposited funds. In addition, funds may be deposited into the primary account through the direct deposit of the sender's government benefit check or paycheck. All funds so deposited are immediately available for transfer according to an exemplary embodiment of the present invention. The customer merely indicates at the ATM 140 the amount of funds to be transferred to the designated transferee subaccount. Once this information is provided at the ATM 140, the funds are moved and the transferee recipient can withdraw the funds from any ATM by using the transferee card and related PIN.

ATM 140 can read the primary account number from the primary account card inserted by the customer and then prompts the sender for the primary account PIN. Once the authorized PIN is provided and verified, the ATM 140 prompts the sender for a transaction request, such as (a) make a deposit into the primary account, (b) make a deposit into a transferee account, and (c) make a transfer from the primary account to a transferee account. However, only those ATM 140s with the special cash and check deposit functionality can be used to initiate such deposits. ATM 140 then communicates the transaction request, including any amount to be deposited or transferred, to processor function 125 such as Concorde EFS, which in turn, advises authorizer function 130 of any new deposits (of cash or checks) made and asks for authorization for any transfers and/or withdrawals. For example, authorizer function 130 such as the authorizer service provided by FiServe, Inc., compares the amount of transfer requested to the amount of funds in the primary account.

Assuming sufficient funds exist in the primary account, authorizer function 130 authorizes the transaction for the full amount of the principal, minus a transaction fee. Authorizer function 130 then advises processor function 125 as to whether the transaction is authorized. Upon receiving authorization, processor function 125 effects the transfer and so notifies authorizer function 130. At the same time, processor function 125 notifies ATM 140 that the transfer is authorized. The primary account holder is advised by the ATM 140 screen that the transfer is complete and the funds are available for immediate withdrawal by the transferee. All of these communications between ATM 140, processor function 125 and authorizer function 130 can take place in real-time. Once credited to the transferee subaccount, the funds are ready to be withdrawn by the recipient. The amount of funds available in the transferee subaccount will be stored in, for example, a database of authorizer 130.

The second part of the transaction for transferring funds according to an embodiment of the present invention is receiving the transferred funds. The withdrawal portion of the transaction begins with the withdrawal request by the transferee, which occurs via second ATM 160. Dispensing ATM 160 may be located anywhere an ATM network connection is available, including, for example, a convenience store, a grocery store, a post office, a branch of a financial institution, a mall, or other location. Dispensing ATM 160 could also be the same machine as initiating ATM 140. The transferee may be prompted by ATM 160 to provide certain pieces of information in order to validate the requested transaction, such as providing information that matches information stored in the database of processor function 125. Such information could include: 1) the principal amount to be dispensed, 2) the transferee card, and/or 3) the PIN issued to that transferee account or issued in connection with that specific transfer. In an exemplary embodiment, the transferee will insert the subaccount card and PIN to start the withdrawal process.

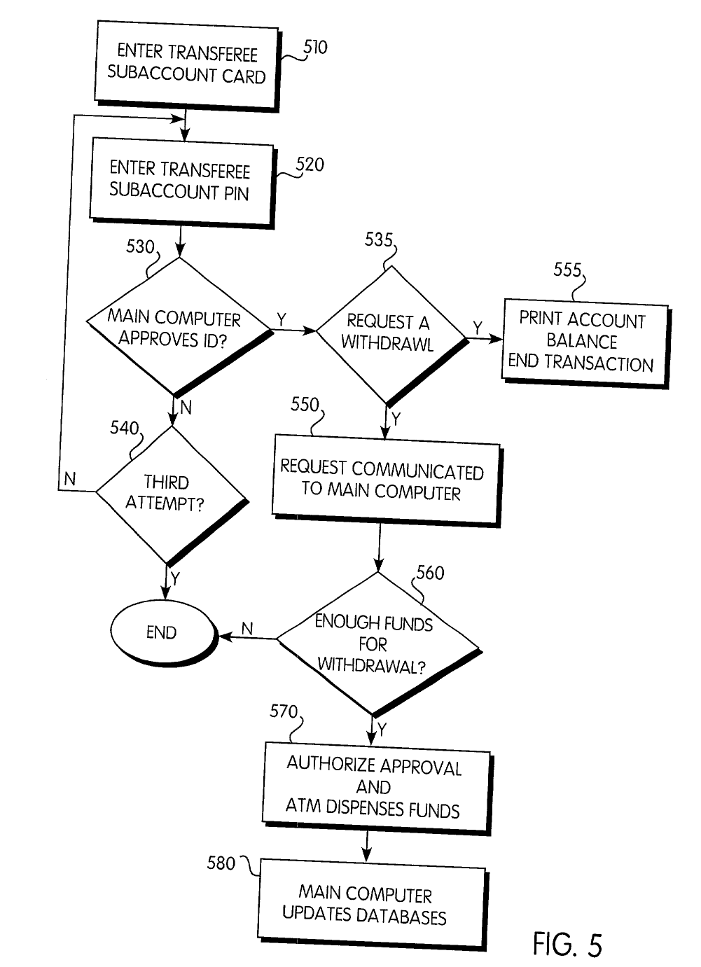

Once the required information has been entered, ATM 160 sends a message to processor function 125 requesting authorization to dispense the principal amount of the transaction. The information input by the transferee is used by authorizer function 130 to determine whether there are sufficient funds in the transferee subaccount (e.g., based on the data stored in its database). ATM 160 will only dispense the funds once the transaction is approved. This procedure is further described with regard to FIG. 5.

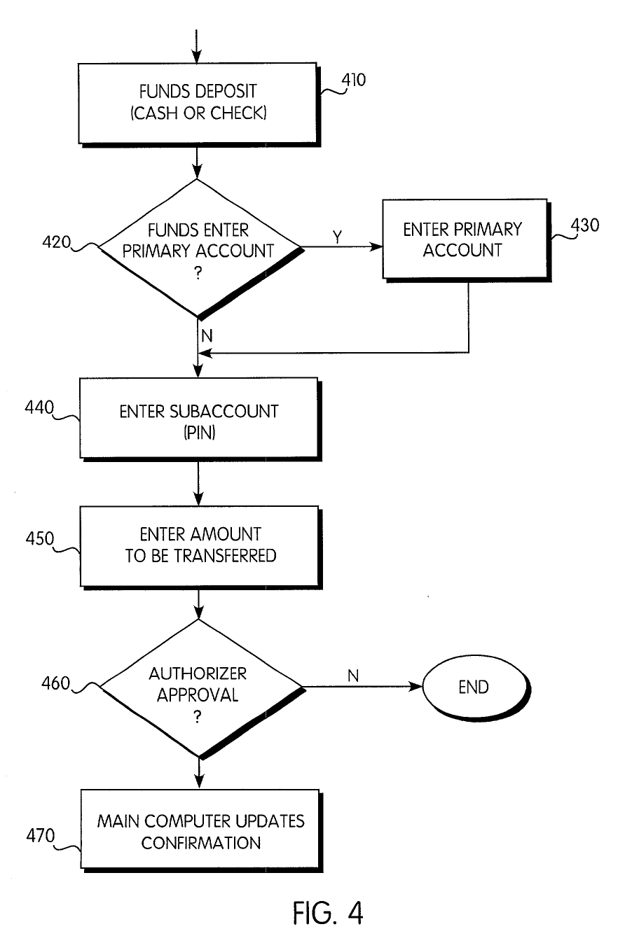

FIG. 4 is an exemplary flowchart illustrating the deposit aspect of a transaction performed according to an exemplary embodiment of the present invention. Following registration of a customer with the funds transfer service, ATM 140 receives a funds deposit (Block 410) from the customer. The funds deposit can be any combination of cash and certain types of checks, as described with regard to FIGS. 1 and 2. ATM 140 then prompts the customer to designate the deposit to either his/her primary account or one of the transferee subaccounts (Block 420). If the customer deposits the funds into the primary account, some or all of the funds can be transferred to a linked transferee subaccount when desired by the customer. Alternatively, the customer can deposit funds directly into a transferee subaccount, particularly if the customer wants to transfer all of the deposited funds to a third party. ATM 140 facilitates the deposit transaction by, for example, prompting the customer for a transfer or deposit request (Block 440) and the amount to be transferred (Block 450). The transaction information is preferably provided from ATM 140 to processor function 125 and authorizer function 130 to obtain authorization approval (Block 460). When approval of the transaction is granted, databases in the computer system 120 are updated with the transaction information, and confirmation is provided to the customer by ATM 140 (Block 470), for example via a printed receipt and/or a visual display.

FIG. 5 illustrates an exemplary flowchart illustrating the withdrawal portion of a transfer transaction performed according to an embodiment of the present invention. To withdraw transferred funds, the recipient would go at ATM 160 and insert the transferee subaccount card (Block 510). ATM 160 would then prompt the transferee to input the transferee subaccount PIN (Block 520). The PIN is then transmitted to main computer 120 for verification (block 530). If the identity of the transferee is confirmed (e.g., the PIN is associated with the subaccount via evaluation by main computer system 120 and ATM 160), then ATM 160 prompts transferee to select the desired transaction. If there is not a match, main computer 120 may transmit a message directing ATM 160 request the recipient reenter the information (Block 540). Once such information has been reentered, ATM 160 again sends the message to main computer 120. While this cycle may be repeated as many times as desired, it is preferably repeated only three times before ATM 160 is directed to end the transaction and reset to wait for the next customer. Once properly identified, the transferee could request to check the account balance or request a withdrawal. (Block 535) Assuming that the transferee requests a withdrawal, the transaction request is then communicated from ATM 160 to main computer 120 (Block 550). Otherwise, an account balance will be printed, and the transaction ends (Block 555).

Main computer 120 receives the withdrawal request and communicates with processor function 125 and authorizer function 130 to determine whether the requesting transferee is entitled to withdraw the amount of requested funds (Block 560). For example, authorizer function 130 compares the withdrawal request amount provided for the transaction with the account information stored in its databases. If the amount requested for withdrawal is the same or less than the transferee subaccount balance, taking into account any fees to be assessed for the transaction, then authorizer function 130 will approve the transaction. This approval is communicated to processor function 125. ATM 160 is then provided with the transaction approval and authorization to dispense the appropriate amount of money (Block 570). The appropriate databases of main computer 120 can then be updated with the transaction information (Block 580).

During the authorization process, authorizer function 130 may invalidate a requested transaction if either the total amount of funds transferred to a subaccount or the total number of transfers to a subaccount exceeds a predetermined limit. For example, the amount of total transaction can be set at $1000 per day, and/or the total number of transactions can be set at five times per day. The amount of any withdrawal or the total number of withdrawals per account may also be limited. This added feature can be used to, for example, identify potentially problematic behavior or activity as desired by the system provider.

Various modifications are apparent to those skilled in the art without departing from the scope and spirit of the present invention. Therefore, the embodiments shown should be considered to be illustrative, not in any manner restrictive.

What is claimed is:

1. A method for transferring money, comprising:
a. creating a transferor primary account coupled to a financial network;
b. creating a transferee account which is a subaccount of the transferor primary account;
c. depositing funds into the transferor primary account, wherein the funds are substantially immediately available for use from the transferor primary account;
d. transferring a portion of the funds in the transferor primary account to the transferee account;
e. creating a transferee account access card and a personal identification number wherein a transferee can withdraw the transferred portion of the funds from any access point in the financial network using the access card and personal identification number.

2. The method of claim 1, wherein the funds include at least one of cash funds and check funds.

3. The method of claim 2, wherein the check funds include one of a government check and a payroll check.

4. The method of claim 1, wherein the financial network includes an automated teller machine (ATM) network.

5. The method of claim 1 wherein a first personal identification number (PIN) is associated with the transferor primary account and a second PIN is associated with the transferee account.

6. The method of claim 1, wherein the transferor primary account and the transferee account are assigned to a customer during one of an on-line registration process and an off-line registration process.

7. The method of claim 6, wherein the registration process is performed via a community based organization or other card distribution center.

8. A method for transferring money, comprising:
a. creating a transferor primary account coupled to a financial network;
b. creating a transferee account which is a subaccount of the transferor primary account;
c. depositing funds into the transferee account wherein the funds are immediately available for use from the transferee account;
e. creating a transferee account access card and a personal identification number wherein a transferee can withdraw the transferred portion of the funds from any access point in the financial network using the access card and personal identification number.

9. A method of transferring money, comprising:
a. depositing funds into a transferor primary account wherein the funds are immediately available for use from the transferor primary account;
b. transferring a portion of the funds in the transferor primary account to a transferee account, wherein the transferee account is a subaccount of the transferor primary account;
c. withdrawing the transferred portion from the transferee account using a transferee account access card and a personal identification number, wherein a transferee can obtain the transferred funds from any access point in the financial network.

10. The method of claim 9, wherein the transfer of the portion of funds is controlled as a function of a number of transfers to the transferee account within a predetermined period of time.

11. The method of claim 10, wherein the total number of transfers to the transferee account is ten times a day.

12. The method of claim 9, wherein the transfer of the portion of funds is controlled as a function of a total amount of funds transferred to the transferee within a predetermined period of time.

13. The method of claim 11, wherein the total amount funds the transferee can withdraw is $1000 a day.

14. The method of claim 9, wherein the funds include at least one of cash funds and check funds.

15. The method of claim 14, wherein the check funds include one of a government check and a payroll check.

16. The method of claim 9, wherein the financial network includes an automated teller machine (ATM) network.

17. The method of claim 9 wherein a first personal identification number (PIN) is associated with the transferor primary account and a second PIN is associated with the transferee account.

18. The method of claim 9, wherein the transferor primary account and the transferee account are assigned to a customer during one of an on-line registration process and an off-line registration process.

19. The method of claim 18, wherein the registration process is performed via a community based organization or other card distribution center.

20. The method according to claim 9, wherein the funds are deposited in an acceptor mechanism of an ATM.

21. The method of claim 20, wherein the acceptor mechanism includes one of a cash bunch acceptor mechanism and an optical check reader/acceptor mechanism.

22. A method of transferring money without using a credit card or a funded bank account, comprising:
a. depositing funds into a transferee account which is a subaccount of a transferor primary account, wherein a portion of the funds are substantially immediately available for use from the transferee account via a publicly available terminal of a financial network;
b. withdrawing a requested amount from the transferee account using a transferee account access card and a personal identification number, wherein a transferee can obtain the requested amount from any access point in the financial network using the access card and personal identification number.

23. The method of claim 22, wherein the publicly available terminal includes an ATM having a funds acceptance mechanism capable of determining an amount of funds deposited into the mechanism.

24. The method of claim 22, wherein in the network includes a ATM network.

25. A system for transferring money without using a credit card or bank account, comprising:
a. a first ATM receiving a funds deposit and a designation of a portion of the funds deposit to be transferred from a transferor's primary account to a transferee account which is a subaccount of the primary account, the first ATM being capable of determining an amount of the funds deposit so that the funds are substantially immediately available for transfer to the transferee account;
b. a central processor system coupled to the first ATM, the central processor receiving deposit transaction data related to the deposit and transfer of funds from the first ATM, at least one database of the central processor being updated with the deposit transaction data; and
c. a second ATM coupled to the central processor system, the second ATM receiving a withdrawal request for funds from the transferee account, the second ATM providing withdrawal transaction data to the central processor system and receiving authorization of the withdrawal request from the central processor system, the at least one database of the central processor system being updated with the withdrawal transaction data, wherein the second ATM dispenses an amount of the withdrawal request in a local currency upon receiving authorization from the central processor system.

26. The system of claim 25, wherein the amount of the withdrawal request is reduced by an amount of a transaction fee.

27. The system of claim 25, wherein the first ATM includes an acceptor mechanism for determining the amount of the funds deposit.

28. The method of claim 27, wherein the acceptor mechanism includes one of a cash bunch acceptor mechanism and an optical check reader/acceptor mechanism.

29. The system of claim 25, wherein the central processor system includes a processor function and an authorizer function.

30. The system of claim 29, wherein the processor function controls the processing of electronic financial transactions at the first ATM and the second ATM.

31. The system of claim 30, wherein the processor function is provided by a computer system operated by a third party service provider.

32. The system of claim 29, wherein the authorizer function controls the authorization of electronic financial transactions at the first ATM and the second ATM.

33. The system of claim 30, wherein the authorizer function is provided by a computer system operated by a third party service provider.

34. A system for transferring money without using a credit card or bank account, comprising:
a. a first ATM receiving a funds deposit to a transferee account which is a subaccount of a transferor primary account, the first ATM being capable of determining an amount of the funds deposit so that the funds are substantially immediately available for use from the transferee account;
b. a central processor coupled to the first ATM, the central processor receiving deposit transaction data related to the deposit of funds from the first ATM, at least one database of the central processor being updated with the deposit transaction data; and
c. a second ATM coupled to the central processor, the second ATM receiving a withdrawal request for funds from the transferee account, the second ATM providing withdrawal transaction data to the central processor and receiving authorization of the withdrawal request from the central processor, the at least one database of the central processor being updated with the withdrawal transaction data, wherein the second ATM dispenses an amount of the withdrawal request in a local currency upon receiving authorization from the central processor.

35. The system of claim 34, wherein the central processor includes computer executable code for
a. creating a transferor primary account coupled to a financial network;
b. creating a transferee account which is a subaccount of the transferor primary account;
c. depositing funds into the transferor primary account, wherein the funds are substantially immediately available for use from the transferor primary account;
d. transferring a portion of the funds in the transferor primary account to the transferee account;
e. creating a transferee account access card and a personal identification number wherein a transferee can withdraw the transferred portion of the funds from any access point in the financial network using the access card and personal identification number.

36. The method of claim 1, wherein the transferor primary account include access to the transferee account and the transferee account includes access only to the transferee account.

37. A system for transferring money comprising:
a. means for creating a transferor primary account coupled to a financial network;
b. means for creating a transferee account which is a subaccount of the transferor primary account;
c. means for depositing funds into the transferor primary account wherein the funds are immediately available for use from the transferor primary account;
d. means for transferring a portion of the funds in the transferor primary account to the transferee account; and
e. means for creating a transferee account access card and a personal identification number wherein a transferee can withdraw the transferred portion of the funds from any access point in the financial network using the access card and personal identification number.

38. A system for transferring money comprising:
b. means for creating a transferor primary account coupled to a financial network;
b. means for creating a transferee account which is a subaccount of the transferor primary account;
c. means for depositing funds into the transferee account wherein the funds are immediately available for use from the transferee account; and
d. means for creating a transferee account access card and a personal identification number wherein a transferee can withdraw the transferred portion of the funds from any access point in the financial network using the access card and personal identification number.
